(19) United States
(12) Patent Application Publication
(10) Pub. No.: US 2018/0036662 A1
(43) Pub. Date: Feb. 8, 2018

(54) SEPARATION APPARATUS

(71) Applicant: EMS Industrial Holdings Limited, Stoke-on-Trent (GB)

(72) Inventor: Sidney John Nash, Stoke-on-Trent (GB)

(21) Appl. No.: 15/229,162

(22) Filed: Aug. 5, 2016

(51) Int. Cl. B01D 33/333; B01D 33/80; C02F 1/00; B01D 33/01

(52) U.S. Cl. CPC B01D 33/333; B01D 33/01; B01D 33/801; C02F 1/004; C02F 1/008; C02F 2103/10

(57) ABSTRACT

A rake classifier assembly including an elongate rake member reciprocally movable up an inclined surface to move solid material thereup is described. A pair of guide arrangements are provided each with a pivotally mounted elongate guide track along which respective wheels connected to the elongate rake member are movable. The guide tracks are selectively movable between first and second alignments, with the guide tracks extending substantially parallel to the inclined surface in the first alignment such that the elongate rake member can be moved up the inclined surface moving solid materials thereup, and in the second alignment the guide tracks diverge downwardly away from the inclined surface, such that as the elongate rake member is moved downwardly the elongate rake member also moves away from the inclined surface.

### FIELD OF THE INVENTION

This invention concerns separation apparatus, and particularly rake classifier assemblies.

### BACKGROUND OF THE INVENTION

Rake classifiers, are used in water treatment installations, as well as in mining and other applications where it is required to separate particulate solids from a liquid. Rake classifiers generally comprise an elongate rake member which is reciprocally moved upwardly from a start position along an inclined surface so as to urge solid material up the inclined surface. Then after a finish position has been reached, the rake member is returned to the start position but with the elongate rake member clear from the inclined surface until the start position is again reached. Rake classifiers are used for instance in water treatment plants to remove gravel, grit and/or other solids from the water.

Typically a rake classifier is provided in a channel leading off a main separating tank, with the water level maintained such that in use most of the elongate member is immersed in liquid, but the upper end in the finished position is above the liquid level.

Prior drive arrangements for the elongate rake member have tended to use relatively complex gear arrangements with an electric motor. Such arrangements are potentially expensive to manufacture and install, and will require periodic not insignificant maintenance.

With rake classifiers it is important to control the speed of the elongate rake member as it moves up the inclined surface. If the elongate rake member is moved too quickly, liquid being displaced can wash solids back down the inclined surface.

### SUMMARY OF THE INVENTION

According to a first aspect of the invention there is provided a rake classifier assembly, the assembly including an elongate rake member reciprocally movable up an inclined surface to move solid material thereup, and a guide arrangement, the guide arrangement including a guide track along which a guide member connected to the elongate rake member is movable, the guide track being selectively movable between first and second alignments, with the guide track extending substantially parallel to the inclined surface in the first alignment such that the elongate rake member can be moved up the inclined surface moving solid materials thereup, and in the second alignment the guide track diverges downwardly away from the inclined surface, such that as the elongate rake member is moved downwardly the elongate rake member also moves away from the inclined surface.

Two guide arrangements may be provided, one towards an upper end of the elongate rake member, and another towards a lower end of the elongate rake member.

In the or each guide arrangement the guide track may be pivotally mounted to a frame so as to be pivotally movable between the first and second alignments, and the pivotal mounting may be provided at an upper end relative to the inclined surface, of the guide track.

The guide track may comprise a spaced pair of elongate guides, and the elongate guides may be in the form of inwardly facing channel section members.

A respective guide member connected to the elongate rake member may be engageable with each elongate guide. The or each guide member may include a wheel movable along the guide track, which wheel may have a rubberized outer surface.

A first linear actuator may be provided for moving the elongate rake member longitudinally relative to the inclined surface. The first linear actuator may be engageable between a frame which mounts the or each guide arrangement, and the elongate rake member.

The, each, or a one of the guide arrangements may include a second linear actuator for selectively moving the guide track between the first and second alignments.

The first and/or second linear actuators may be in the form of cylinders, which may be hydraulically or pneumatically controlled. Alternatively the first and/or second linear actuators may be in the form of linear motors.

Where two or more guide arrangements are provided, a one only of the guide arrangements may include a second linear actuator, and linkage means may be provided extending between the guide arrangement with a second linear actuator and the other guide arrangement or arrangements, to provide for equivalent movement of each guide arrangement.

The elongate rake member may include a plurality of spaced transverse members extendable across the inclined surface to move solid material thereup.

The elongate rake member may include a frame which mounts the spaced transverse members, and the or each guide member.

The rake classifier assembly may be computer controlled, and may be configured such that the elongate rake member can be moved at different speeds respectively up and down the inclined surface. The rake classifier assembly may be configured such that the elongate rake member can be paused at a maximum upward position of the inclined slope to allow liquid to drain back down the slope.

Sensors may be provided to detect the location of one or more of the movable components of the rake classifier assembly.

According to a second aspect of the invention there is provided a solid and liquid separation installation, the installation including a rake classifier assembly according to any of the preceding thirteen paragraphs.

The installation may include a main separation chamber with an outlet leading thereof to the inclined slope.

### BRIEF DESCRIPTION OF THE DRAWINGS

An embodiment of the present invention will now be described by way of example only and with reference to the accompanying drawings, in which:

FIG. 1 is a diagrammatic perspective view of a first rake classifier assembly according to the invention;

FIGS. 2-5 are diagrammatic side views of the assembly of FIG. 1 respectively in first, second, third and fourth positions;

FIG. 6 is a diagrammatic perspective view of a solid and liquid separation installation according to the invention;

FIG. 7 is a diagrammatic plan view of the installation of FIG. 6;

FIG. 8 is a diagrammatic cross-sectional view along the line A-A of FIG. 7; and

FIG. 9 is a similar view to FIG. 1 but of a second rake classifier assembly according to the invention.

### DETAILED DESCRIPTION OF THE INVENTION

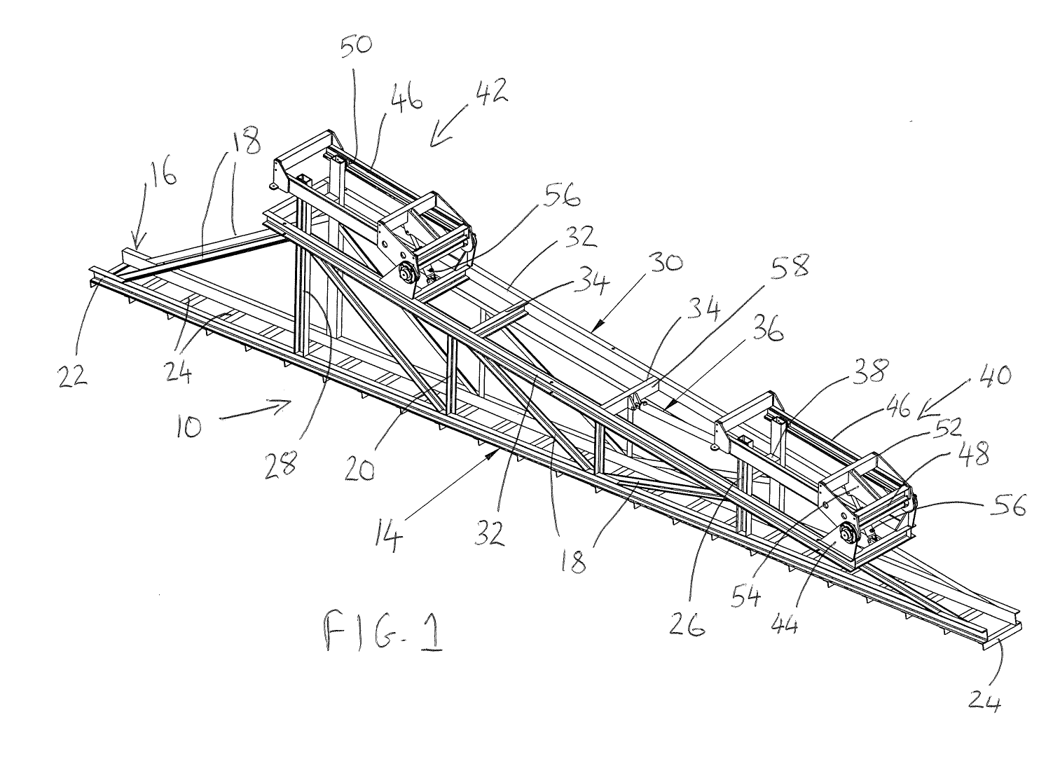

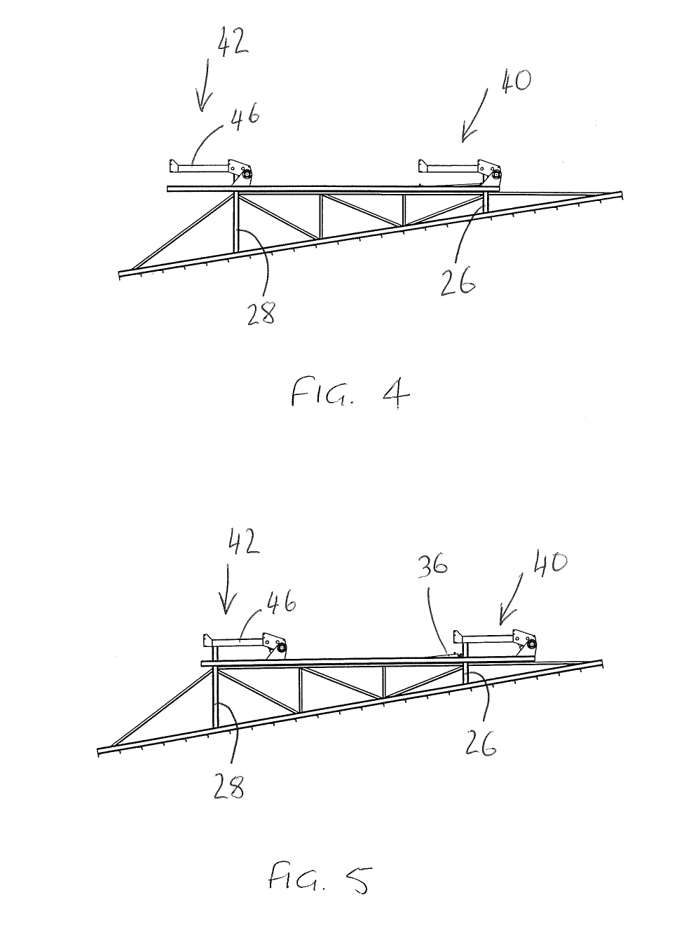

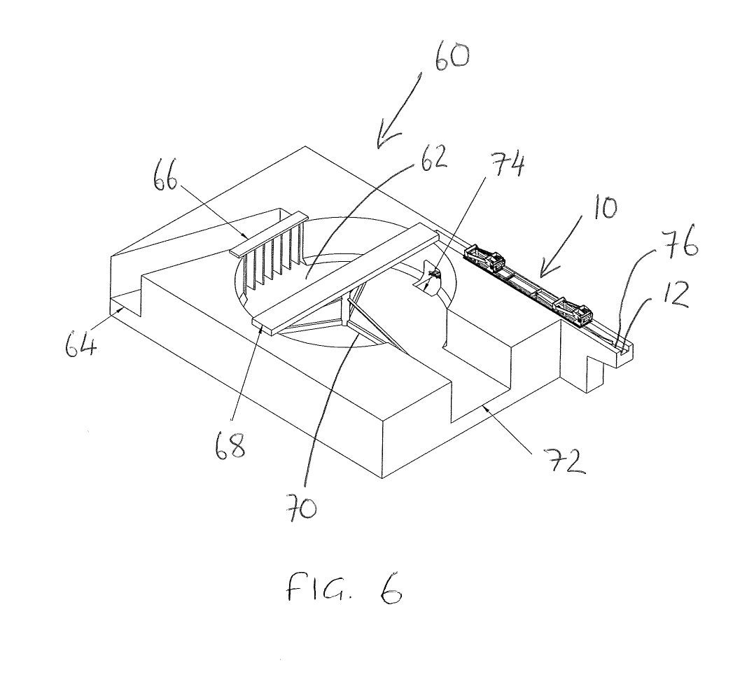

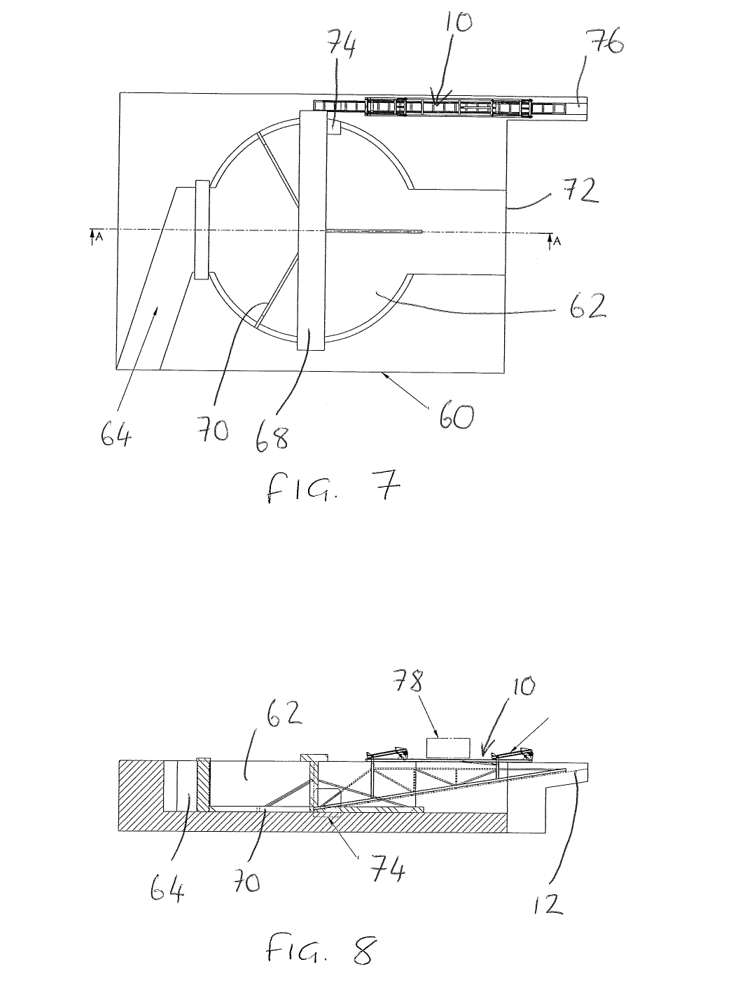

FIGS. 1 to 8 of the drawings show a first rake classifier assembly 10 suitable for moving solids up an inclined surface 12 as shown in FIGS. 6 to 8. The assembly 10 includes an elongate rake member 14 which has a frame 16 with two sides, each side including a plurality of inclined members 18 interconnected to a plurality of upright members 20. The frame 16 mounts a spaced pair of lower rails 22 in the form of outwardly facing channel section. Extending between and beneath the lower rails 22 are a plurality of spaced scraper members 24 in the form of lengths of downwardly facing angle iron. The uppermost 26 and lowermost 28 upright members 20 extend above the remainder of the upright members 20 and inclined members 18.

The assembly 10 also comprises a rectangular frame 30 comprising two elongate outer members 32 and a plurality of cross-members 34. The uppermost and lowermost upright members 26, 28 extend through and above the frame 30.

A first hydraulic cylinder 36 extends to the right as shown in FIGS. 1 to 5 from a one of the cross members 34 to engage with a cross member 38 extending between the uppermost upright members 26. Operation of the first hydraulic cylinder 36 causes relative longitudinal movement between the elongate rake member 14 and frame 30.

A pair of identical guide arrangements 40, 42 are mounted on top of the frame 30 with a first guide arrangement 40 provided at the upper right hand end of the frame 30, and the second guide arrangement 42 provided at the lower left hand end of the frame 30. Each guide arrangement 40, 42 comprises a pair of brackets 44 at the upper end which pivotally mount a spaced pair of elongate guides 46 in the form of a pair of inwardly facing lengths of channel section. The lower ends of the guides 46 are interconnected by a cross member 48. Each elongate guide 46 rotatingly mounts a respective rubberized wheel 50 provided on the outer side at the top thereof on respectively the uppermost and lowermost upright members 26, 28.

Also extending between the brackets 44, and connected to the elongate guides 46 is an n-shaped bracket arrangement 52 with a central support 54. A second hydraulic cylinder 56 extends between the cross piece of the end bracket arrangement 52 and a respective cross member 58 of the frame 30, such that operation of the second hydraulic cylinder 56 provides for pivotal movement of the elongate guides 46 relative to the frame 30.

The second hydraulic cylinders 56 may have a common hydraulic supply with a splitter provided for the supply to the respective cylinders 56.

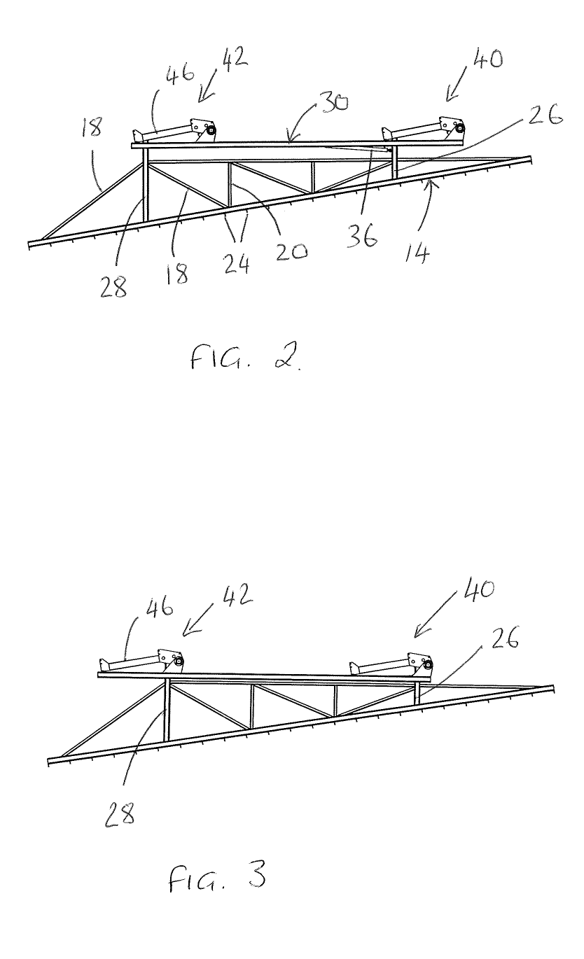

FIGS. 2 to 5 sequentially show operation of the rake classifier assembly 10. In FIG. 2 the assembly 10 is shown in a first starting position with the elongate rake member 14 at the lowermost position on the inclined surface 12, with the elongate guides 46 inclined downwardly extending parallel to the inclined surface 12. The wheels 50 are located at the lowermost (left hand) ends of the elongate guides 46.

The elongate rake member 14 is then moved up the inclined surface 12 by actuation of the first hydraulic cylinder 36 to the position shown in FIG. 3 where the wheels 50 are at the uppermost (right hand) ends of the elongate guides 46. In operation the assembly 10 may be paused at this position to enable any liquid pushed up with solids urged up by the scraper members 24, to drain back down the inclined surface 12.

The second hydraulic cylinders 56 are now operated to bring the elongate guides 46 to a horizontal alignment as shown in FIG. 4. The elongate rake member 14 is now moved downwardly and to the left as shown in the drawings by operation of the first hydraulic cylinder 36. As the elongate guides 46 now extend horizontally, as the elongate rake member 14 moves to the left it actually moves horizontally such that it moves clear of the inclined surface 12 and therefore clear of solid material on the inclined surface 12 so as not to push such material back down.

When the elongate rake member 14 has reached the fully downwards, i.e. leftward extent, it will occupy the position as shown in FIG. 5 and also FIG. 1. The elongate rake member 14 can now be lowered onto the inclined surface 12 by actuation of the second hydraulic cylinders 56 such that the elongate guides 46 return to an alignment parallel to the inclined surface 12 to the position shown in FIG. 2. The process can now be repeated with solid material being moved further up the inclined surface 12.

FIGS. 6 to 8 show a typical water treatment installation 60 incorporating the rake classifier assembly 10. The installation 60 includes a main tank 62 with an inlet 64 controlled by adjustable vanes 66 to maintain a required level in the main tank 62. A bridge 68 with a three arm rotating scraper 70 is provided in the main tank 62, and will rotate slowly in use. An outlet 72 to the main tank 62 is provided diametrically opposite the inlet 64.

Solids will drop out of the liquid in the main tank 62 and be moved by the scraper 70. A grit collection trap 74 is provided which leads to the inclined surface 12 in the form of an inclined channel 76. The grit rake assembly 10 will move the solids up the inclined channel 76 clear of the liquid therein, for further processing.

The rake classifier assembly 10 will be computer controlled, and a control unit 78 is provided including control for the assembly and also a hydraulic power unit for the first and second hydraulic rams 36, 56. The control unit 78 can be programmed as required and could for instance provide a relatively slow upward movement of the elongate rake member 14 to ensure that liquid does not wash solids back down the inclined surface 12. As indicated a pause may be provided with the elongate rake member 14 at the upper position. The return of the elongate rake member downwardly could however be carried out more quickly to enable a further lifting sequence to rapidly commence.

Proximity sensors may be provided to detect the location of the various movable components of the assembly, and the assembly could be controlled in the light of the detected locations.

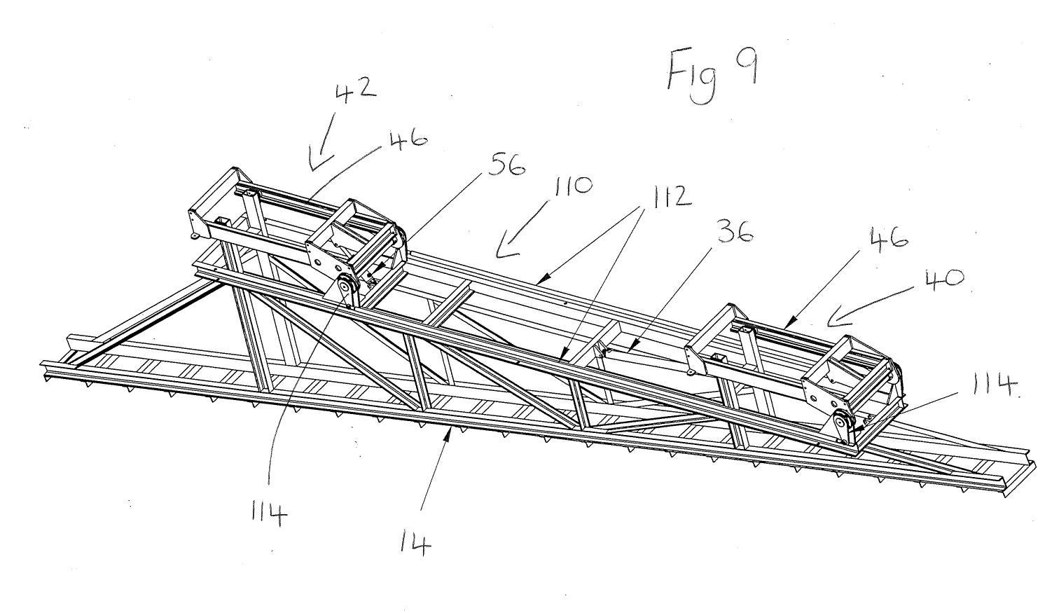

FIG. 9 shows a second rake classifier assembly 110 which is similar in most respects to the first assembly 10, and the same reference numerals has been used or equivalent features. In the assembly 110 only the upper second guide arrangement 42 has a second hydraulic cylinder 56, and the first guide arrangement 40 has no hydraulic cylinder.

Crank members 114 are provided on the outside of each of the guide arrangements 40, 42 mounted at one end coaxially with the cross members 48, with the other ends of the crank members 114 pivotally mounting connecting rods 112 which extend between the respective crank members 114 on the first and second guide arrangements 40, 42. This means that as the second hydraulic cylinder 56 on the second guide arrangement 42 is actuated to pivotally move the elongate guides 46, this causes equivalent pivotal movement of the elongate guides 46 on the first guide arrangement 40.

There are thus described a rake classifier assemblies and also a water treatment installation incorporating such an assembly which has been found to have a number of advantageous features. The operation of the assemblies is relatively simple and can thus provide long term low maintenance operation. These assemblies can also be robustly and inexpensively manufactured.

The rake classifier assemblies can be controlled as required, and as indicated could move in different directions at different speeds, and could be paused in position as required. With such controllable arrangements it has been found for instance that the assembly could operate on a steeper inclined surface than would otherwise be the case, as the assemblies can be controlled to prevent solids being washed back down the slope. Accordingly the assembly could be provided in a smaller space than would otherwise be possible.

It is to be realized that a wide range of other modifications may be made without departing from the scope of the invention. For instance the cylinders could be pneumatically rather than hydraulically controlled, or other control means could be used, such as linear motors. It may be that a different number of guide arrangements would be used. The elongate rake member may take a different form.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A rake classifier assembly, the assembly including an elongate rake member reciprocally movable up an inclined surface to move solid material thereup, and a guide arrangement, the guide arrangement including a guide track along which a guide member connected to the elongate rake member is movable, the guide track being selectively movable between first and second alignments, with the guide track extending substantially parallel to the inclined surface in the first alignment such that the elongate rake member can be moved up the inclined surface moving solid materials thereup, and in the second alignment the guide track diverges downwardly away from the inclined surface, such that as the elongate rake member is moved downwardly the elongate rake member also moves away from the inclined surface.

2. An assembly according to claim 1, in which two guide arrangements are provided, one towards an upper end of the elongate rake member, and another towards a lower end of the elongate rake member.

3. An assembly according to claim 1, in which in the guide arrangement the guide track is pivotally mounted to a frame so as to be pivotally movable between the first and second alignments.

4. An assembly according to claim 3, in which the pivotal mounting is provided at an upper end relative to the inclined surface, of the guide track.

5. An assembly according to claim 1, in which the guide track comprises a spaced pair of elongate guides.

6. An assembly according to claim 5, in which a respective guide member connected to the elongate rake member is engageable with each elongate guide.

7. An assembly according to claim 6, in which the or each guide member includes a wheel movable along the guide track.

8. An assembly according to claim 1, in which a first linear actuator is provided for moving the elongate rake member longitudinally relative to the inclined surface.

9. An assembly according to claim 8, in which the first linear actuator is engageable between a frame which mounts the or each guide arrangement, and the elongate rake member.

10. An assembly according to claim 1, in which the guide arrangement includes a second linear actuator for selectively moving the guide track between the first and second alignments.

11. An assembly according to claim 10, in which two guide arrangements are provided, one towards an upper end of the elongate rake member, and another towards a lower end of the elongate rake member, and a one only of the guide arrangements includes a second linear actuator.

12. An assembly according to claim 11, in which linkage means is provided extending between the guide arrangement with a second linear actuator and the other guide arrangement or arrangements, to provide for equivalent movement of each guide arrangement.

13. An assembly according to claim 1, in which the elongate rake member includes a plurality of spaced transverse members extendable across the inclined surface to move solid material thereup.

14. An assembly according to claim 13, in which the elongate rake member includes a frame which mounts the spaced transverse members, and the or each guide member.

15. An assembly according to claim 1, in which the rake classifier assembly is computer controlled.

16. An assembly according to claim 15, in which the rake classifier assembly is configured such that the elongate rake member can be moved at different speeds respectively up and down the inclined surface.

17. An assembly according to claim 15, in which the rake classifier assembly is configured such that the elongate rake member can be paused at a maximum upward position of the inclined slope to allow liquid to drain back down the slope.

18. An assembly according to claim 1, in which sensors are provided to detect the location of one or more of the movable components of the rake classifier assembly.

19. A solid and liquid separation installation, the installation including a rake classifier assembly according to claim 1.

20. An installation according to claim 19, in which the installation includes a main separation chamber with an outlet leading thereof to the inclined surface.
